(19) United States
(12) Patent Application Publication
(10) Pub. No.: US 2014/0185417 A1
(43) Pub. Date: Jul. 3, 2014

(54) SYSTEM AND METHOD FOR MULTI-USER CALENDAR SYNCHRONIZATION AND STATISTICAL ANALYSIS THEREOF

(71) Applicant: Ge Zhao, Surrey (CA)

(72) Inventor: Ge Zhao, Surrey (CA)

(21) Appl. No.: 13/733,143

(22) Filed: Jan. 3, 2013

(51) Int. Cl. G04G 99/00

(52) U.S. Cl. CPC G04G 99/00
USPC 368/28

(57) ABSTRACT

The present invention generally relates to computer and web-based calendaring systems. Specifically, this invention relates to systems and methods for synchronizing, organizing and analyzing calendars, events and the scheduling thereof. Embodiments of the present invention allow one or more users to schedule events based on specific categorizations, search and match calendar availability and usage based on such specific categorizations, both on their own schedule and the schedule of others, and provide statistical analysis of personal and third-party calendars based on time utilization and categorization of events/time spent.

### FIELD OF THE INVENTION

The present invention generally relates to computer and web-based calendaring systems. Specifically, this invention relates to systems and methods for synchronizing, organizing and analyzing calendars, events and the scheduling thereof. Embodiments of the present invention allow one or more users to schedule events based on specific categorizations, search and match calendar availability and usage based on such specific categorizations, both on their own schedule and the schedule of others, and provide statistical analysis of personal and third-party calendars based on time utilization and categorization of events/time spent.

### BACKGROUND

The use of calendars for scheduling and recordkeeping has been ubiquitous for centuries. In the current age, the world has seen systemic integration of personal computers and other computing devices (e.g., smartphones, tablet PCs, laptops) into daily life. The marriage of these two components has not been overlooked as almost every computing device has a date/time function as well as at least some simplistic calendar feature.

Calendaring systems in use currently on computing devices are generally simplistic event and appointment scheduling tools, allowing users to schedule events, appointments and other meetings (collectively referred to herein as “events”) without significant or meaningful classification or categorization of these events.

Certain systems currently available in the art allow for sharing calendar events with others, such as for scheduling meetings amongst multiple potential attendees. Still other systems allow for the synchronization of calendars amongst devices of a single user or allowing third-parties to view events on the calendar of another. Again, these simplistic features are useful, but fail to realize the potential that exists in the data associated with these calendaring systems.

Modern electronic calendaring systems lack at least four significant features that would otherwise be advantageous to have in a distributed calendaring system (i.e., a calendaring system shared with one or more users, preferably via a networked/web-based system). Those four significant features are: (i) the ability to schedule calendar events with relevant classifications and other pertinent information that would allow for optimization and tracking of such events; (ii) the ability to search for events based on one or more relevant classifications or other pieces of pertinent information (other than time/date, simple search strings); (iii) the ability to match individuals with other individuals based on past, present or future expenditures of time for specific purposes or based on other relevant classifications or pertinent information; and (iv) the ability to generate and provide statistical analysis of events and individual scheduling characteristics in order to allow for dissemination of time utilization metrics.

Therefore, there is need in the art for a computer based calendaring system and method that provides at least one, but preferably all four, of the above identified features. These and other features and advantages of the present invention will be explained and will become obvious to one skilled in the art through the summary of the invention that follows.

### SUMMARY OF THE INVENTION

Accordingly, it is an aspect of the present invention to provide a computer based calendaring system and method for providing one or more of: (i) the ability to schedule calendar events with relevant classifications and other pertinent information; (ii) the ability to search for events based on one or more relevant classifications or other pieces of pertinent information; (iii) the ability to match individuals with other individuals based on past, present or future expenditures of time for specific purposes or based on other relevant classifications or pertinent information; and (iv) the ability to generate and provide statistical analysis of events and individual scheduling characteristics in order to allow for dissemination of time utilization metrics.

According to an embodiment of the present invention, a system for providing advanced calendar synchronization and filtration includes: a calendar system module comprising computer-executable code stored in non-volatile memory; a search engine module comprising computer-executable code stored in non-volatile memory; a processor; and a communications means, wherein said calendar system module, said search engine module, said processor, and said communications means are operably connected and are configured to: receive a request from a first user regarding calendars of one or more users; identify a purpose for said request, wherein said purpose is selected from the group comprising retrieval of calendar elements, retrieval of profile data, filtering of calendar data and filtering of profile data; and process said request based on said purpose, wherein said processing includes one or more of retrieving one or more calendar elements from a data store, retrieving one or more profile elements from said data, filtering said one or more calendar elements based on data contained in said request, and filtering said one or more profile elements based on data contained in said request.

According to an embodiment of the present invention, the system is further configured to generate statistical information about one or more calendar elements associated with said one or more users.

According to an embodiment of the present invention, the system is further configured to provide said statistical information to said user.

According to an embodiment of the present invention, the system is further configured to predict future calendar elements based on said statistical information.

According to an embodiment of the present invention, the system is further configured to filter said statistical information based on said request.

According to an embodiment of the present invention, the system is further configured to associate one or more of said predicted future calendar elements with the calendar of said user.

According to an embodiment of the present invention, the system is further configured store said one or more of said predicted future calendar elements.

According to an embodiment of the present invention, a web-based method for providing advanced calendar synchronization and filtration includes: receiving a request from a first user regarding calendars of one or more users; identifying a purpose for said request, wherein said purpose is selected from the group comprising retrieval of calendar elements, retrieval of profile data, filtering of calendar data and filtering of profile data; and processing said request based on said purpose, wherein said processing includes one or more of retrieving one or more calendar elements from a data store, retrieving one or more profile elements from said data, filtering said one or more calendar elements based on data contained in said request, and filtering said one or more profile elements based on data contained in said request.

According to an embodiment of the present invention, the method includes the step of generating statistical information about one or more calendar elements associated with said one or more users.

According to an embodiment of the present invention, the method includes the step of providing said statistical information to said user.

According to an embodiment of the present invention, the method includes the step of predicting future calendar elements based on said statistical information.

According to an embodiment of the present invention, the method includes the step of filter said statistical information based on said request.

According to an embodiment of the present invention, the method includes the step of associating one or more of said predicted future calendar elements with the calendar of said user.

According to an embodiment of the present invention, the method includes the step of storing said one or more of said predicted future calendar elements.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3 is a schematic of an exemplary embodiment of a web-based system in accordance with an embodiment of the present invention;

FIG. 4 is a schematic of an exemplary embodiment of a local system in accordance with an embodiment of the present invention;

FIG. 5-5B are flowcharts of an exemplary methods in accordance with embodiments of the present invention; and

FIGS. 6A-6P are exemplary embodiments of a graphical user interface (GUI) showing an embodiment of the present invention in use.

### DETAILED SPECIFICATION

The present invention generally relates to computer and web-based calendaring systems. Specifically, this invention relates to systems and methods for synchronizing, organizing and analyzing calendars, events and the scheduling thereof. Embodiments of the present invention allow one or more users to schedule events based on specific categorizations, search and match calendar availability and usage based on such specific categorizations, both on their own schedule and the schedule of others, and provide statistical analysis of personal and third-party calendars based on time utilization and categorization of events/time spent.

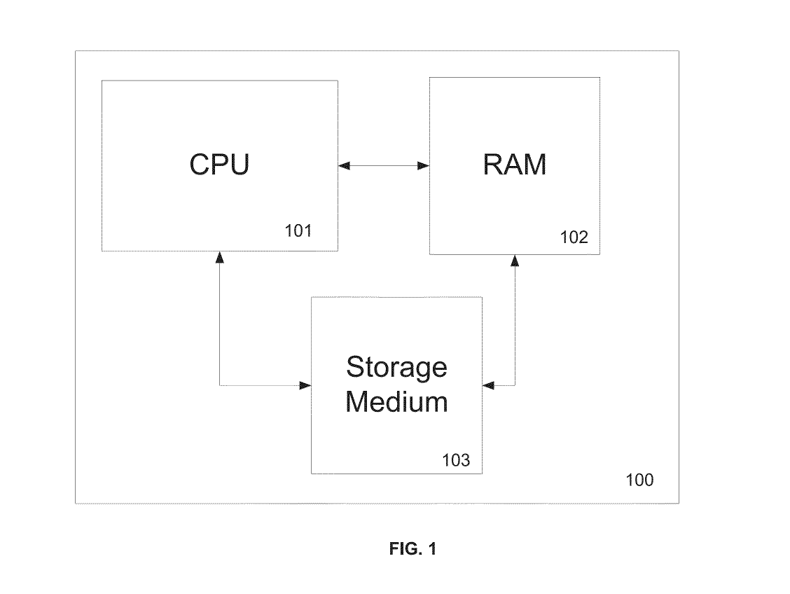

According to an embodiment of the present invention, the systems and methods are accomplished through the use of one or more computing devices. As shown in FIG. 1, one of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

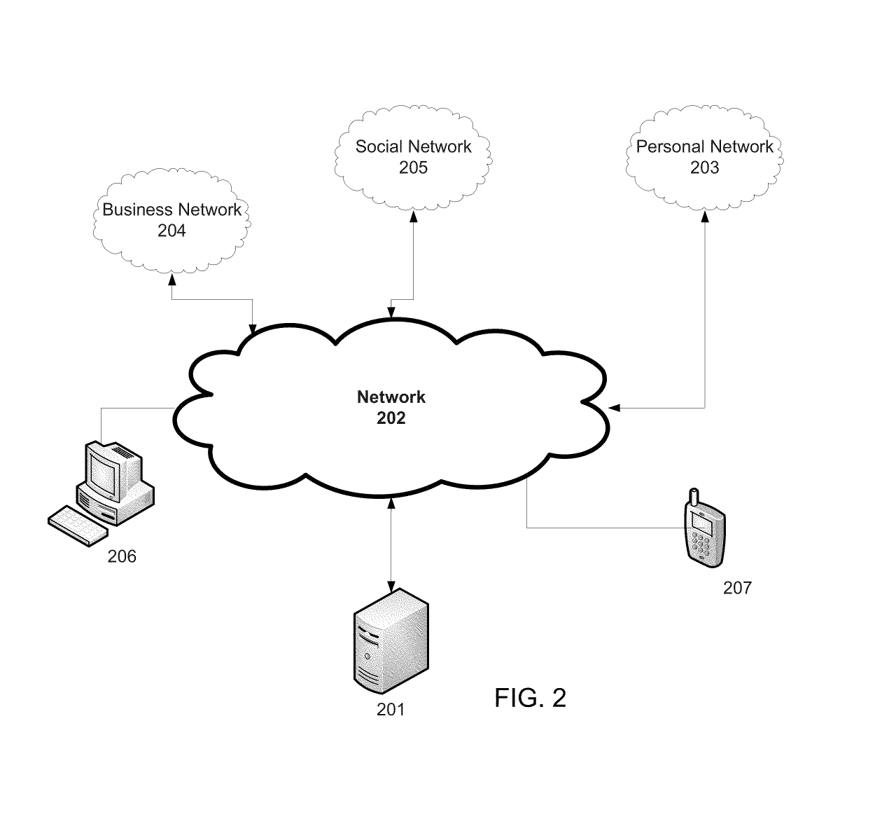

Referring to FIG. 2, a schematic overview of a system in accordance with an embodiment of the present invention is shown. The system is comprised of one or more application servers 201 for electronically storing information used by the system and providing processing of data for presentation to users who remotely connect to the application servers 201 through a networked connection. For instance, one or more application programming interfaces (API) may be provided by the application servers 201, across the Internet, for use and consumption by one or more computing devices belonging to one or more users of the system.

Applications in the application server 201 may retrieve and manipulate information in storage devices and exchange information through a WAN 202 (e.g., the Internet). Applications in application server 201 may also be used to manipulate information stored remotely and process and analyze data stored remotely across a WAN 202 (e.g., the Internet).

According to an exemplary embodiment, as shown in FIG. 2, exchange of information through the WAN 202 or other network may occur through one or more high speed connections. In some cases, high speed connections may be over-the-air (OTA), passed through networked systems, directly connected to one or more WANs 202 or directed through one or more routers. Router(s) are completely optional and other embodiments in accordance with the present invention may or may not utilize one or more routers or other networking hardware/software systems. One of ordinary skill in the art would appreciate that there are numerous ways application server 201 may connect to WAN 202 for the exchange of information, and embodiments of the present invention are contemplated for use with any method for connecting to networks for the purpose of exchanging information. Further, while this application refers to high speed connections, embodiments of the present invention may be utilized with connections of any speed.

Users (e.g., PC user 206, smartphone user 207) of the system may connect to application server 201 via WAN 202 or other network in numerous ways. For instance, a component may connect to the system i) through a computing device 206 directly connected to the WAN 202, ii) through a computing device 206 connected to the WAN 202 through a routing device or other networking device, iii) through a computing device 207 via a wireless connection (e.g., CDMA, GMS, 3G, 4G) to the WAN 202. One of ordinary skill in the art would appreciate that there are numerous ways that a component may connect to application server 201 via WAN 202 or other network, and embodiments of the present invention are contemplated for use with any method for connecting to application server 201 via WAN 202 or other network. Furthermore, application server 201 could be comprised of a personal computing device, such as a smartphone, acting as a host for other computing devices to connect to.

Further, with regards to FIG. 2, the systems and methods provided herein could be used in conjunction with, receive information from, communicate information to or otherwise integrate with one or more third-party networks, which may include their own processing and data handling components, such as business networks 204, social networks 205 and personal networks 203. Each third-party network may be comprised of one or more computing devices and may be capable of functioning independently from the systems described herein.

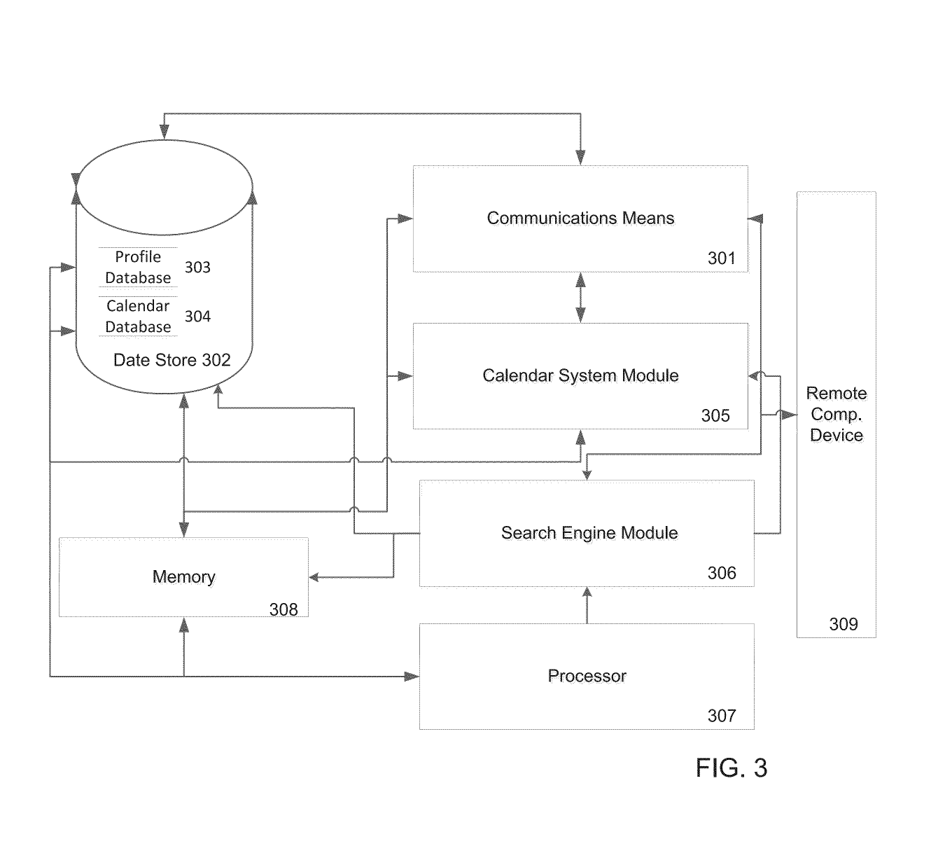

Turning now to FIG. 3, according to an embodiment of the present invention, the system and methods herein described may be implemented through the use of one or more computing devices comprising a communications means 301, one or more data stores 302 comprising one or more of a profile database 303 and a calendar database 304, a calendar system module 305, a search engine module 306, a processor 307 and a memory 308. One or ordinary skill in the art would appreciate that there are numerous types of processors that could be utilized with embodiments of the present invention as well as numerous types of memory (e.g., Flash, RAM, ROM, cache, storage), and embodiments of the present invention are contemplated for use with any type of processor and memory.

According to an embodiment of the present invention, the communications means of the graphic alignment engine may be, for instance, any means for communicating data over one or more networks. Appropriate communications means may include, but are not limited to, wireless connections, wired connections, cellular connections, data port connections, Bluetooth connections, fiber optic connections, modems, network interface cards or any combination thereof. One of ordinary skill in the art would appreciate that there are numerous communications means that may be utilized with embodiments of the present invention, and embodiments of the present invention are contemplated for use with any communications means.

According to an embodiment of the present invention, data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data.

In a preferred embodiment, the data store may comprise one or more profile databases and calendar databases. Profile databases are configured to store information related to one or more users of the calendaring system described herein. User information may include, but is not limited to, gender, age, hobbies, activities, profession, educational background, associations, memberships, likes, dislikes or any combination thereof. One of ordinary skill in the art would appreciate that there are numerous types of user information that could be utilized by the system and stored in one or more profile databases, and embodiments of the present invention are contemplated for use with any type user information.

According to an embodiment of the present invention, calendar databases are configured to store information related to one or more calendar elements and/or organizational and classification information associated with those elements. Calendar elements are objects comprising all the information a system has about a particular calendar event, including, but not limited to, the date, time, location, event type (e.g., office meeting, concert, child's birthday), category (e.g., hobby, work, free, occupation, not available, assigned), attire (e.g., casual, business, formal), movable (i.e., can an event be rescheduled) or any combination thereof. One of ordinary skill in the art would appreciate that there are numerous types of information that could be used and stored in a calendar element, and embodiments of the present invention are contemplated for use with any appropriate information.

According to an embodiment of the present invention, the calendar module is configured to provide the system with direct functionality related to the calendar elements stored in the calendar database of the data store. This functionality extends the stored data into utilizable content elements for consumption by the end user(s). The calendar module provides users the ability to utilize the functionality of the systems and methods described herein.

According to an embodiment of the present invention, a first level of the calendar module provides users the ability to utilize basic calendaring system functionality as realized in the present art, such as adding an event, sharing/viewing a calendar with other users and collecting data regarding one or more users. Data collected regarding events and users may be stored in one or more of the profile database and the calendar database.

According to an embodiment of the present invention, a second level of the calendar module extends the basic calendaring system functionality by allowing users to create calendar elements, as opposed to just events. Instead of simply entering an appointment for a specific date/time on a calendar, the system, by way of the calendar module, provides the user to include relevant element information as noted above, including attendee information, attire, whether the event is movable, the type of event, the category of the event or any combination thereof. By including this additional data, the system is able to generate a much more detailed analysis of the calendar elements and the behavioral, social, work and other patterns associated with one or more users.

According to an embodiment of the present invention, calendar events may be initiated by third-parties with respect to a user. For instance, a user may allow its employer to add or request addition of events (e.g., meetings) to their calendar. Events in this manner may be classified in part by the entity initiating the request. For instance, an event received from a social network may be initially classified (if not otherwise specified) as a social event and an event received from a business network could be initially classified (if not otherwise specified) as a work event. In this manner, the system can be configured to allow initiation of events from numerous providers, including an individuals, work, social networks, third-party applications, service providers (e.g., doctors, repairman).

According to an embodiment of the present invention, the calendar module may be configured to automatically extract certain information from event submissions provided by users. As noted above, if a calendar event is initiated from a business network, the calendar module can interpret this as a work event. In other cases, text recognition and analysis software can be utilized to determine the nature, type and other characteristics of the event. For instance, the calendar module could receive a request from a concert hall about an upcoming concert the user bought a ticket to. The event may not be formatted particularly for use with the calendaring system of the present invention, but the event may contain certain identifiable information, such as the address, time and location of the event. This information could be extracted and saved by the calendar module for use and confirmation by the user at a later time.

According to an embodiment of the present invention, the calendar module, in conjunction with the data store, allows for real-time or near real-time synchronization of calendar data, whether individually or across multiple users. This allows for real-time accuracy with respect to available and unavailable times across all calendars associated with the system. Optionally, the system may be further comprised to work collectively with software or other applications installed on one or more user's computing devices or links to third-party services (e.g., social networks, business networks, personal networks) to automatically identify changes to the user's profile or schedule to allow for instant synchronization with the profile database and calendar database. For instance, a user may have linked their favorite social network service to the system, allowing for instant changes to a user's profile and calendar in the system upon update on the social network (e.g., user got engaged, user becomes single, user has a child, user accepts an event invite).

According to an embodiment of the present invention, the search engine module is configured to provide search and filtering functionality to the systems and methods described herein. The search engine module provides users the ability to filter calendar elements on one or more pieces of information or other characteristics. Further the search engine module may be configured to provide filtering across the calendars of one or more users simultaneously, providing capability for cross-calendar matching and filtering. Advantageously, multiple users can search and synchronize their schedules with other users to identify best times to take on an activity.

Since calendar elements are categorized beyond just time/date/location, the search engine module can be configured to identify calendar elements across numerous factors via searching and filtering. For instance, if a group of friends who are all girls wants to get together for a “girls night”, they could simply use the system to match the next available time that: (i) is at night; (ii) is limited to friends of the female gender; (iii) all proposed participants are free (i.e., not otherwise unavailable due to other calendar elements); and (iii) all proposed participants have allotted the free time as not assigned to other types of activities (e.g., free time is set aside for recreational events).

As noted above, the system can be configured to allow users to mark times and dates on their calendar for particular activities or mark them for specific categorizations via one or more characteristics or other pieces of information. For instance, the system may allow for a user to block of Friday night for recreation and Tuesday night for study time. The system can leave those calendar times open for calendar elements to be inserted upon, but only if those calendar elements fit the appropriate characteristics (e.g., Friday night is only for recreation, so a study session could not be inserted on a Friday night).

According to an embodiment of the present invention, the system, through the use of one or more of the components as a collective system, can be configured to provide results to a user via a graphical user interface that allows for convenient display of the various calendar elements in a cohesive display. In certain embodiments, users may be allowed to see calendars and calendar elements of other users. In preferred embodiments, before a first user is provided access to second user's calendar, the user must first be confirmed or provided access by the second user.

According to an embodiment of the present invention, the system, through the use of one or more of the components as a collective system, can be configured to analyze and generate statistical information about users based on their patterns of time utilization and scheduling. The system can be further configured to utilize this statistical data to generate matching criteria and other predictive features to the users of the system.

According to an embodiment of the present invention, the statistical data can be derived from the detailed information stored in the event elements of each user. This data can also be cross referenced and associated with the profile elements of a user. Statistical data may include, but is not limited to, how a user spends their time (e.g., how much time in work pursuits, how much time in recreational pursuits, how much time in assigned time, how much time in unassigned time, how much time in presence of others, how much time in presence of those of the same/opposite gender), who the user spends their time with, where the user spends their time, the types of events the user attends, the frequency with which a user cancels or moves events or any combination thereof.

According to an embodiment of the present invention, this statistical data can be used to make predictions about the user. The more statistical data the system has about the user, the better the predictions. For instance, if the system is aware that the user is at work every Monday from 9-5 with a 95% likelihood, the system can predict, even where the user has not scheduled work on their calendar in the future at that time, that the user will be unavailable for recreational pursuits on a given Monday in the future.

This data can become very granular as multiple-users become involved in the creation of statistical data. For instance, if it is statistically shown that if a select number of friends (e.g., 5, 6,7) are invited on Friday nights to go to a recreational event, they will attend, but if fewer than that number are invited, the probability is lower, than the system can note this, present this to the user, or otherwise show that time as unavailable during filtering unless the filter includes friends in excess of the number where the probability of accepting such an invite exceeds a certain threshold.

In this manner, scheduling can be made in to a deterministic or predictive model, whereby the system can identify ideal times for individuals or groups of individuals to perform specific events or actions. For instance, the system can identify ideal times for groups to go on vacation, based on previous vacationing times, locations, events, or any combination thereof.

One of ordinary skill in the art would appreciate that there are numerous manners in which the statistical information could be formed and utilized, and embodiments of the present invention are contemplated for use with any manner for generating and utilizing the statistical information.

### Exemplary Embodiment

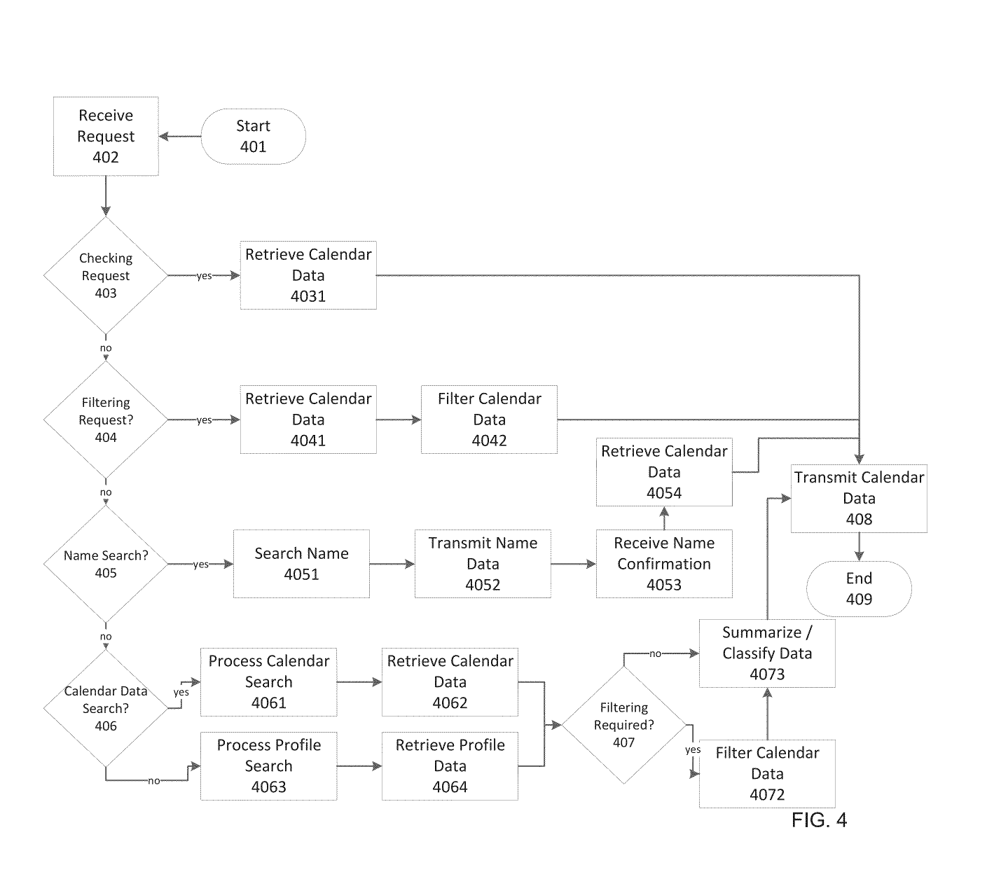

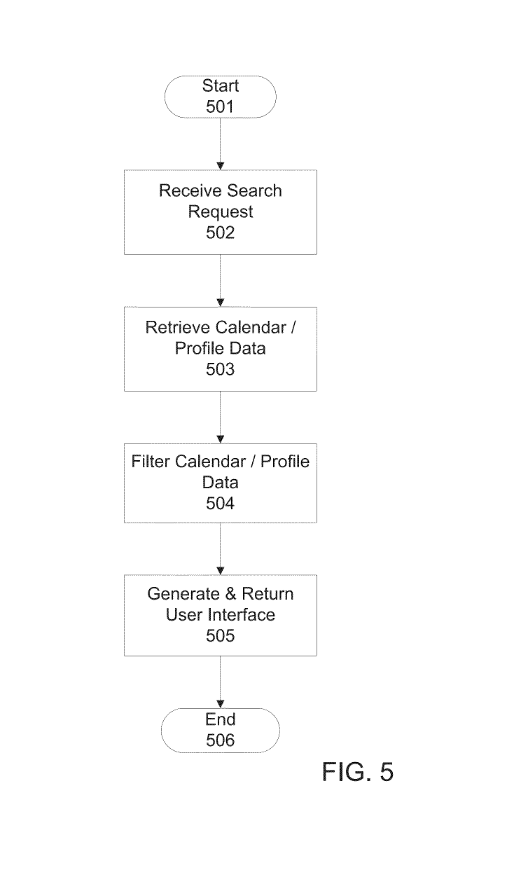

Turning now to FIG. 4, an exemplary method in accordance with an embodiment of the present invention is shown. The method starts at step 401, at which point the system is contacted by a user. The system receives a request for accessing or performing some action on one or more calendars at step 402.

At step 403, the system checks to see if the request is from a user interested in reviewing a calendar. If so, the system retrieves the calendar of the user at step 4031, transmits the calendar information requested to the user at step 408 and the process ends at step 409.

If the request is not a request to check a calendar, the system proceeds to check if the request is a filtering request (step 404). If the request is a filtering request, the system retrieves the relevant data at step 4041; filters the data at step 4042 based on criteria identified in the request from the user; and transmits the calendar data to the user at step 408. At that point, the process ends at step 409.

If the request is not a filtering request, the system checks to see if the request is a name search (step 405). If the request is a name search request, the system proceeds to search the data store for the name at step 4051. At step 4052, the system transmits the name data to the user for verification. The user then verifies the name (step 4053) and the system proceeds to retrieve the calendar data associated with the name search at step 4054. In certain embodiments, the system may first validate whether (i) the user making the request has permission to access the calendar associated with the name; or (ii) the calendar is otherwise publicly available for review. At step 408, the system transmits the data to the user and the process terminates at step 409.

If the request is not a name search, the system checks to see if the request is a calendar data search (step 406). If it is, the process proceeds to step 4061 and processes the calendar data search and retrieves the relevant calendar data (step 4062). If it is not, the system processes the request as a profile search, processes the relevant profile search data (step 4063) and retrieves the relevant profile data (step 4064). In either of these flows, the system then checks to see if filtering of the data provided is required (step 407). If filtering is required, the system filters the data at step 4072. In either case, the system then proceeds to summarize and classify the data at step 4073 and then transmits the filtered data to the user at step 408, with the process ending at step 409.

With respect to the steps of FIG. 4, one of ordinary skill in the art would appreciate that the searching steps (e.g., 4061, 4063, 4051), filtering steps (e.g., 4042, 4072) and retrieving steps (e.g., 4031, 4041, 4054, 4062, 4064) could be done in any order or nearly any order. While the steps are numbered and ordered in FIG. 4 provided, the steps could occur in any number of different combinations or orderings, with certain embodiments consisting of fewer or additional steps. Choice of ordering and inclusion/exclusion of steps may be based at least in part on type of data store utilized (e.g., relational database, data store, object repository).

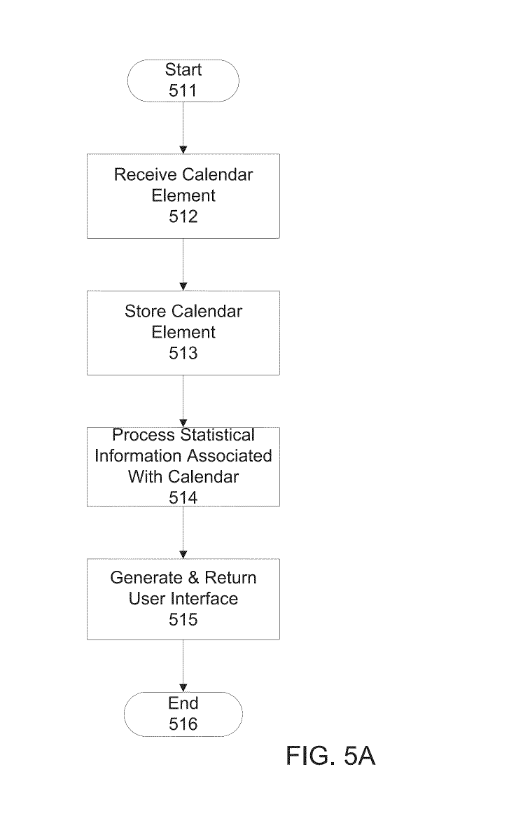

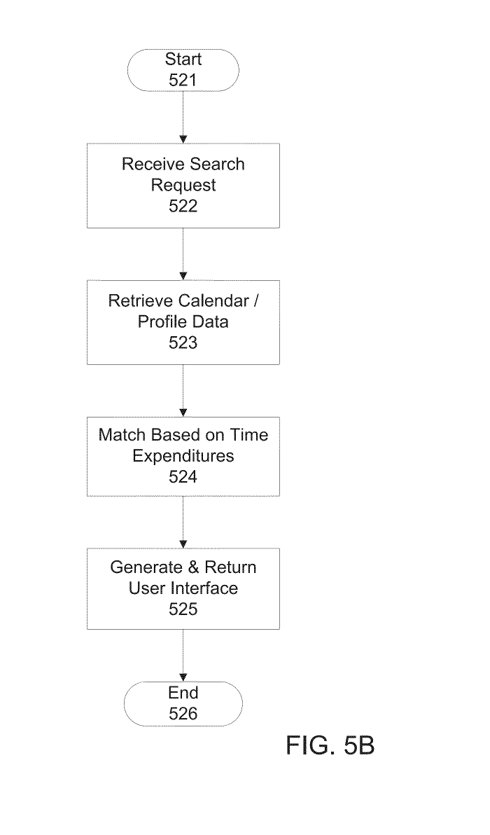

Turning now to FIG. 5, an exemplary process flow for advanced calendar searching as enabled by the system is shown. The process starts at step 501 with contact being received from a user. At step 502, the system processes the contact into a request which has been identified by the system as a search request.

At step 503, the system retrieves relevant calendar data, comprising one or more calendar elements, from the calendar database and profile data, comprising one or more profile elements, from the profile database. Calendar data and profile data may be retrieved which references one or more users, depending on the number of calendars involved in the search.

At step 504, the system filters the retrieved profile and calendar data based on filtering parameters received from the user in the request. A subset of all calendar elements and profile elements may be constructed from this filtering.

At step 505, the system generates and returns an appropriately formatted user interface or relevant data package from the subset of calendar elements and profile elements generated during the filtering step. This provides the user with a formatted calendar or calendar data set based upon the calendars, profiles and filters identified by the user in previous steps. At step 506, the process terminates.

Turning now to FIG. 5A, an exemplary process flow for storing calendar elements and generating statistical information related to calendar elements as enabled by the system is shown. The process starts at step 511 with contact being received from a user; in this case the contact is for the insertion of one or more calendar elements into one or more user's calendars. At step 512, the system processes the contact into a calendar element submission request. Prior to processing the request, the system may be configured to authenticate one or more security protocols and logins (multiple security protocols and logins may be required if the calendar element is to be processed for multiple users at the same time).

At step 513, the system has validated the user(s) and processed the request for inserting the calendar element into the calendars of one or more users. At this step, the system also stores information related to the calendar event into the relevant data stores, which may include updated profile information, updated calendar information or any combination thereof.

At step 514, the system processes statistical information about the calendar element for the users associated with the element. This may include, but is not limited to, processing statistical information regarding the type of event, the type of time associated with the event (e.g., work, hobby, free, study), the number of attendees at the event (predicted prior to event, actual after event), the duration of the event and affiliated associations amongst various users where matching is based on statistical time utilization amongst users. It should be noted that the characteristics of an event element may vary amongst users, for instance a calendar event may be considered relaxation time for one person (e.g., vacationer) and work time for another person (e.g., bartender at the vacation spot).

At step 515, the system generates and returns an appropriately formatted user interface or relevant data package as updated by the generation of the statistical information in step 514. In certain embodiments, this may provide the user with a formatted calendar or calendar data set based upon the calendars, profiles and filters identified by the user in previous steps. At step 516, the process terminates.

Turning now to FIG. 5B, an exemplary process flow for matching users based on time expenditures, as enabled by the system is shown. The process starts at step 521 with contact being received from a user; in this case the contact is for the matching of the user with one or more other users based on one or more criteria. At step 522, the system processes the contact into a calendar matching request. Prior to processing the request, the system may be configured to authenticate one or more security protocols and logins (such as verifying the user has access to matching profiles or identifying appropriate publicly available profile data for matching).

At step 523, the system has validated the user and processed the matching request criteria. Criteria for the matching request may be standard matching (e.g., match 2 or more users with similar time expenditures, free time matches, or other common matching components). In the alternative, criteria may be selected to allow users to identify matches with one or more individuals that are not similar to themselves (e.g., a user may wish to be matched with someone who spends much more time on hobbies/relaxation than themselves). In any event, once the criteria has been established, the system retrieves profile and calendar data for appropriate potential matches.

At step 524, the system processes matches based on the criteria provided and the information retrieved from the profile and calendar data stores. Matches may be weighted based on the importance or relevance of certain criteria. The system can be further configured to require a match to be greater than a certain threshold before considering a potential match an actual match (e.g., the potential match meets at least 50% of the criteria identified in the request).

At step 525, the system generates and returns an appropriately formatted user interface or relevant data package containing the one or more matched results identified in step 524. In certain embodiments, this may provide the user with a formatted calendar or calendar data set based upon the calendars, profiles and filters identified by the user in previous steps. At step 526, the process terminates.

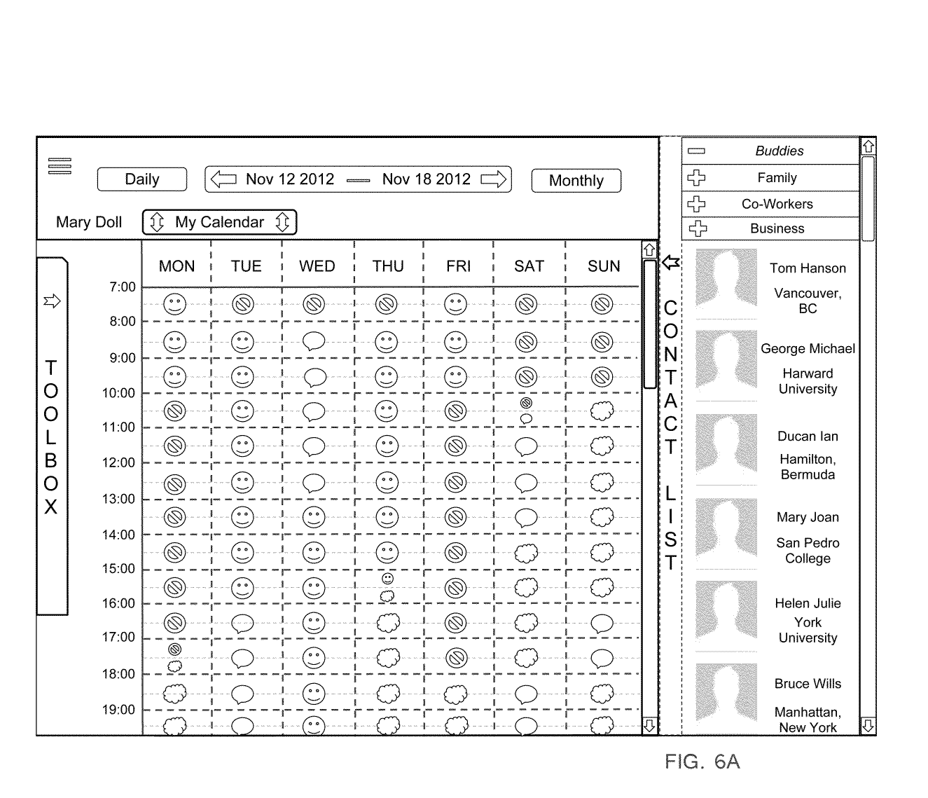

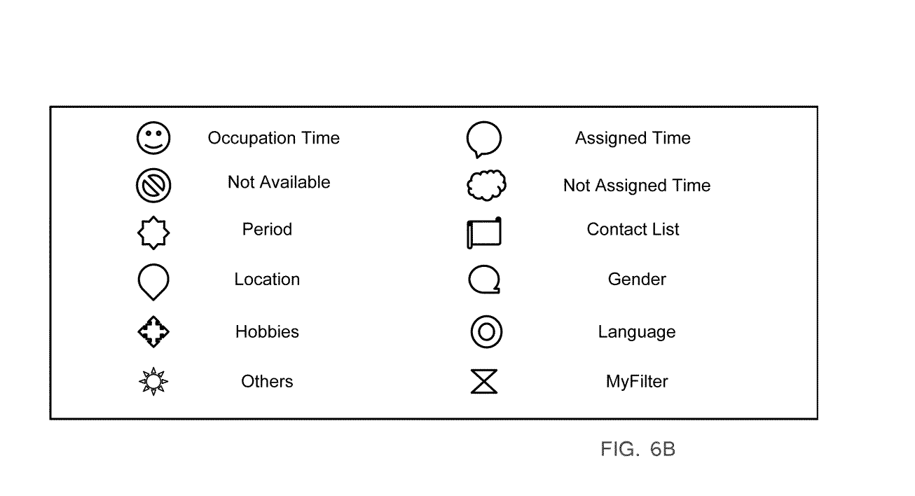

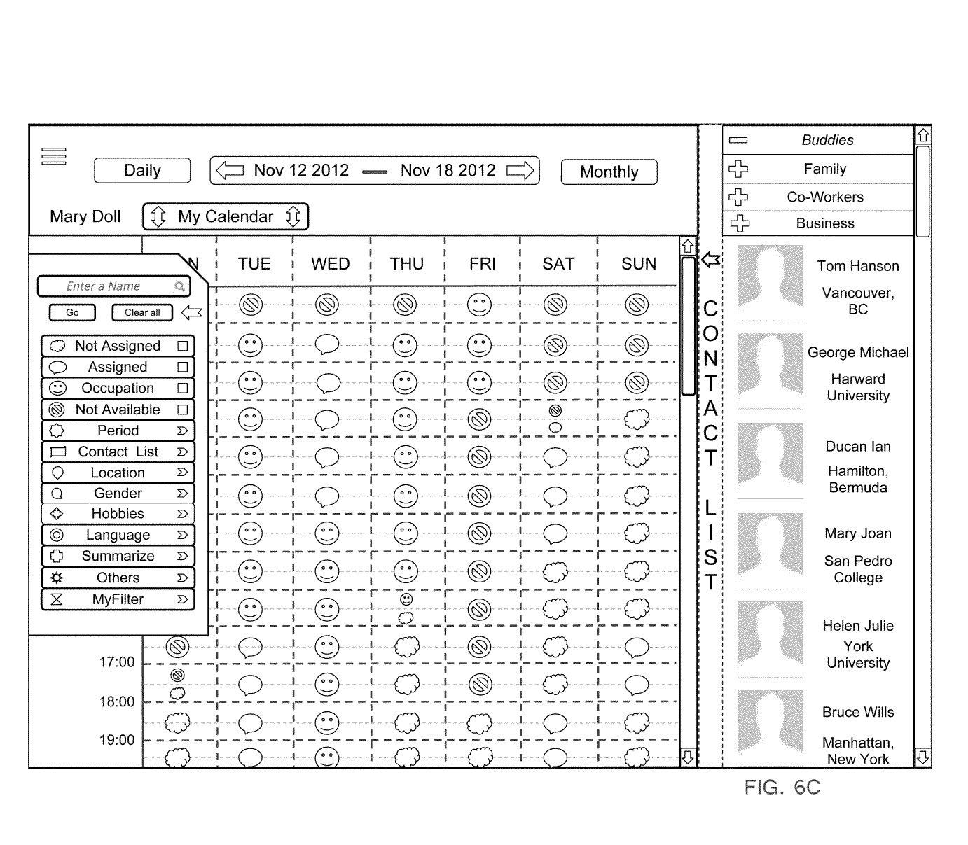

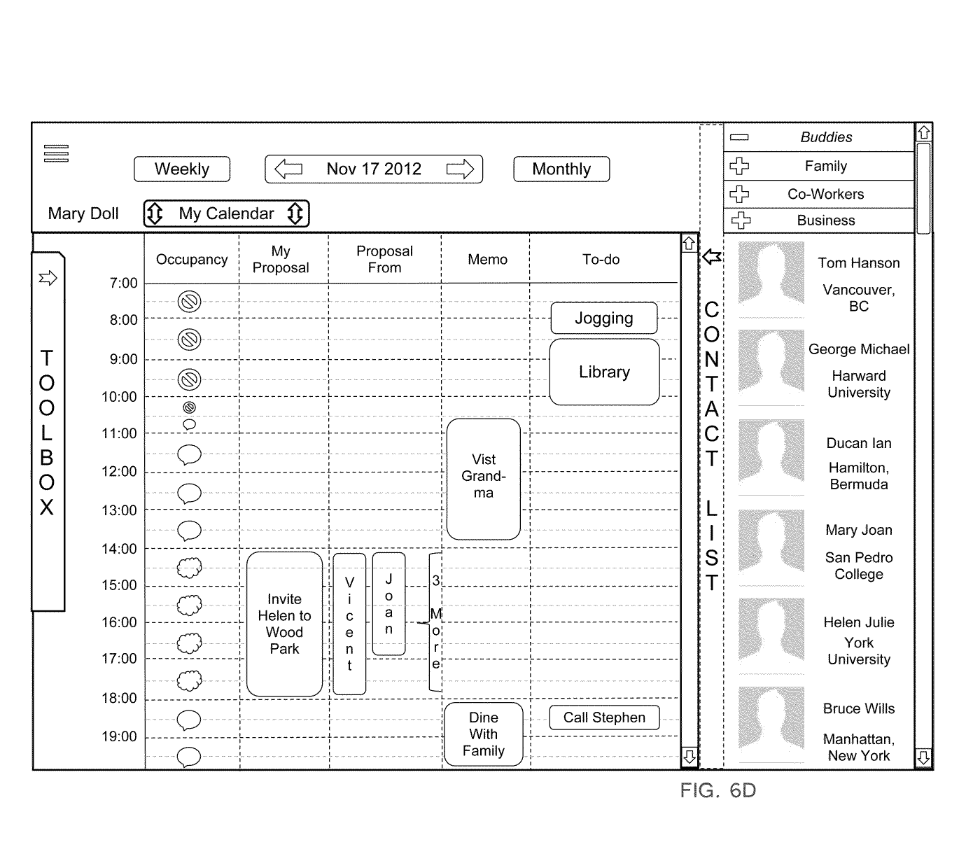

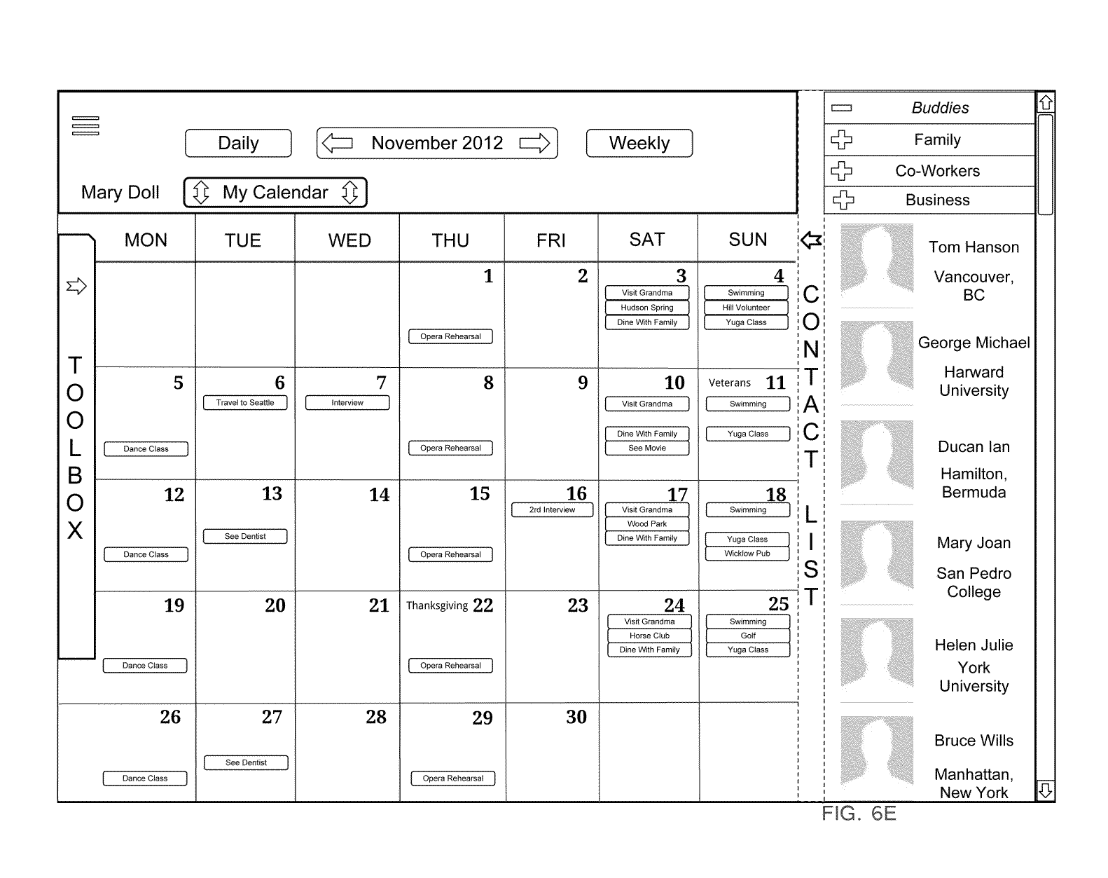

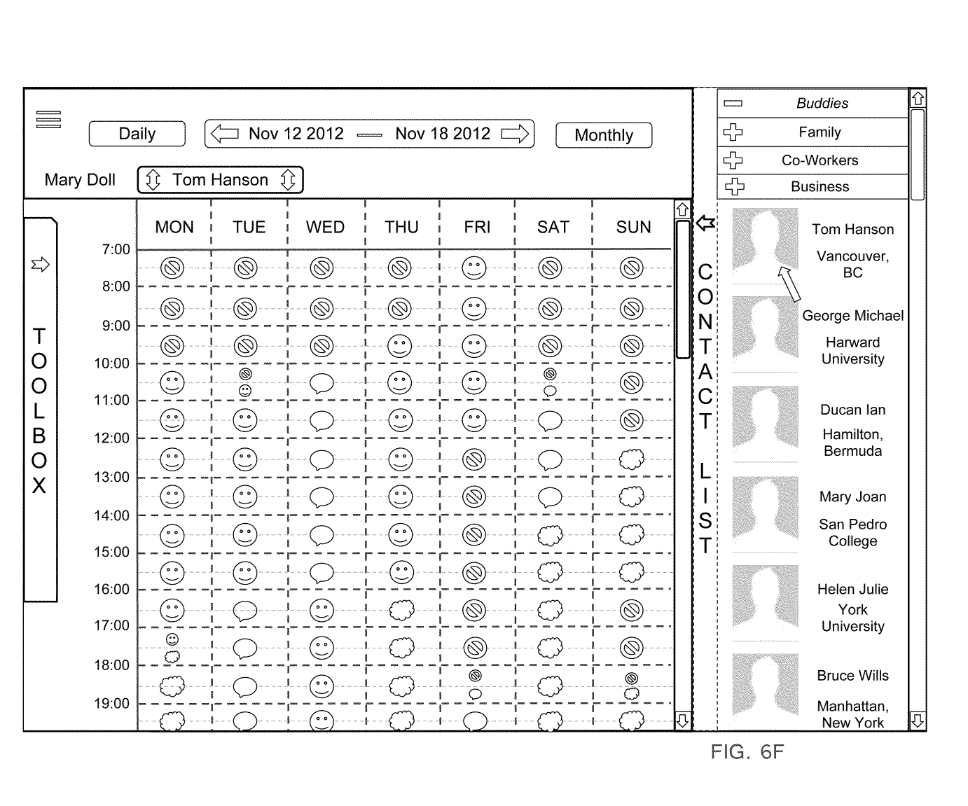

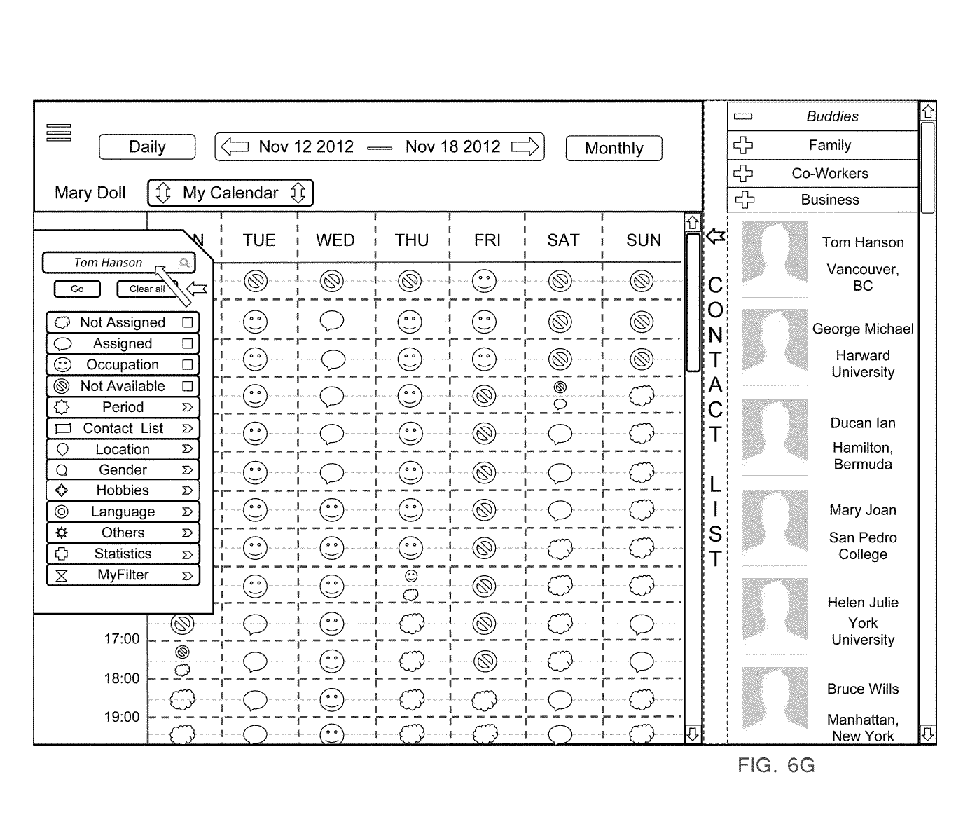

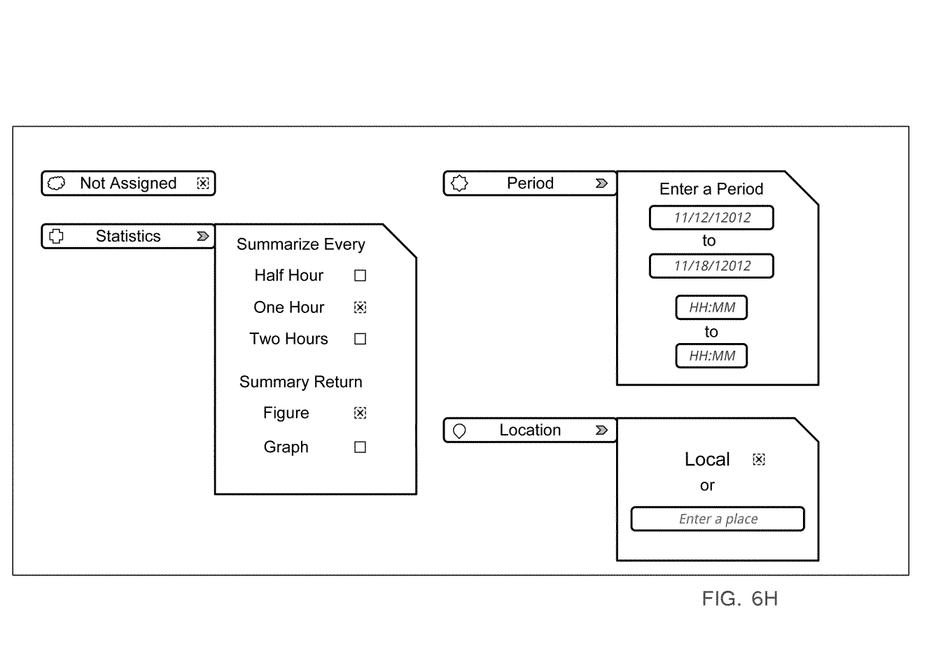

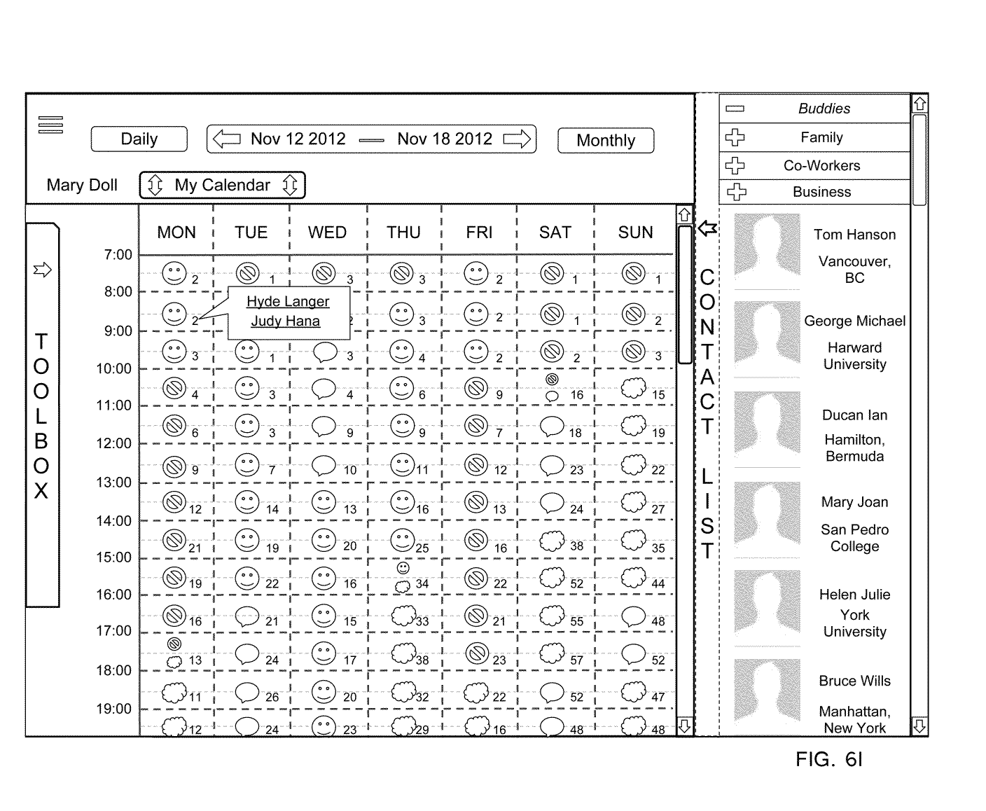

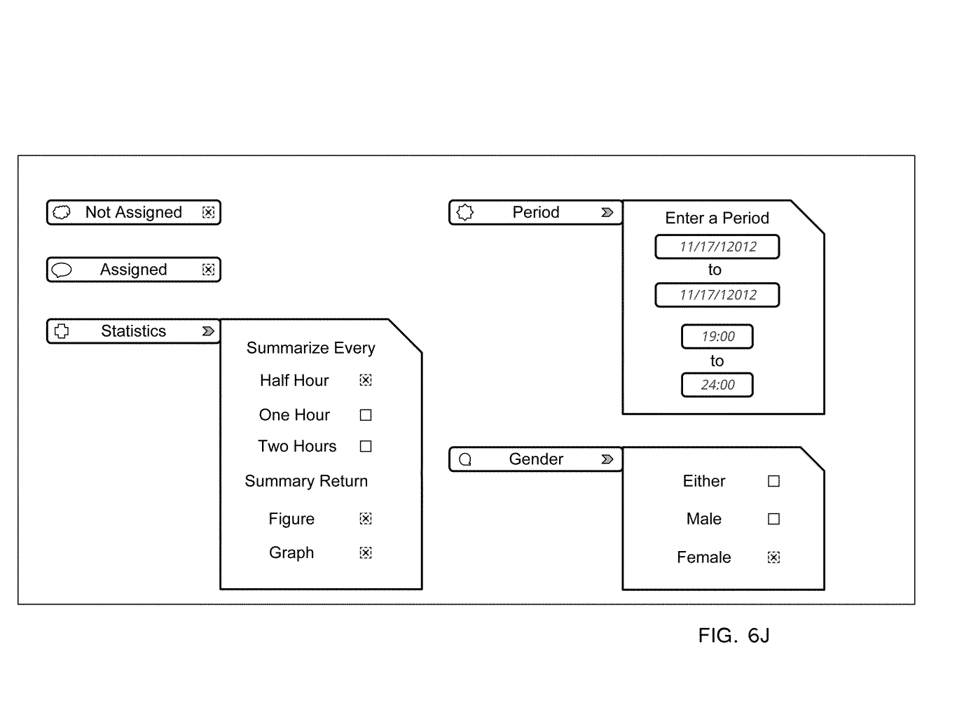

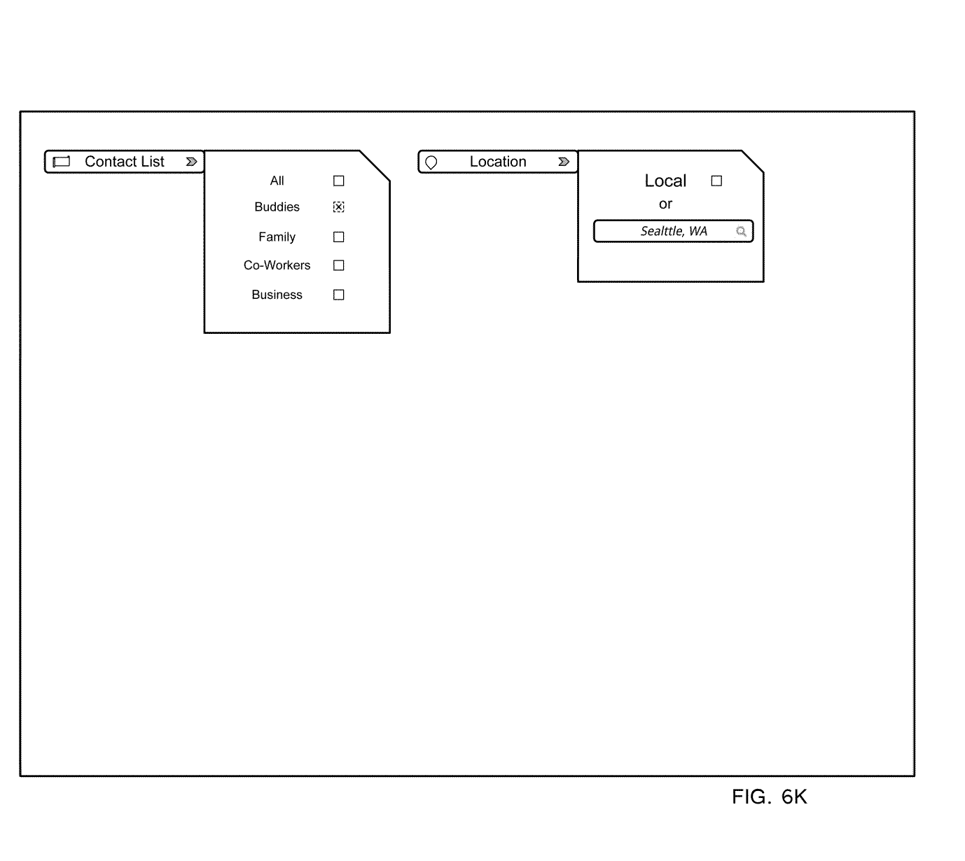

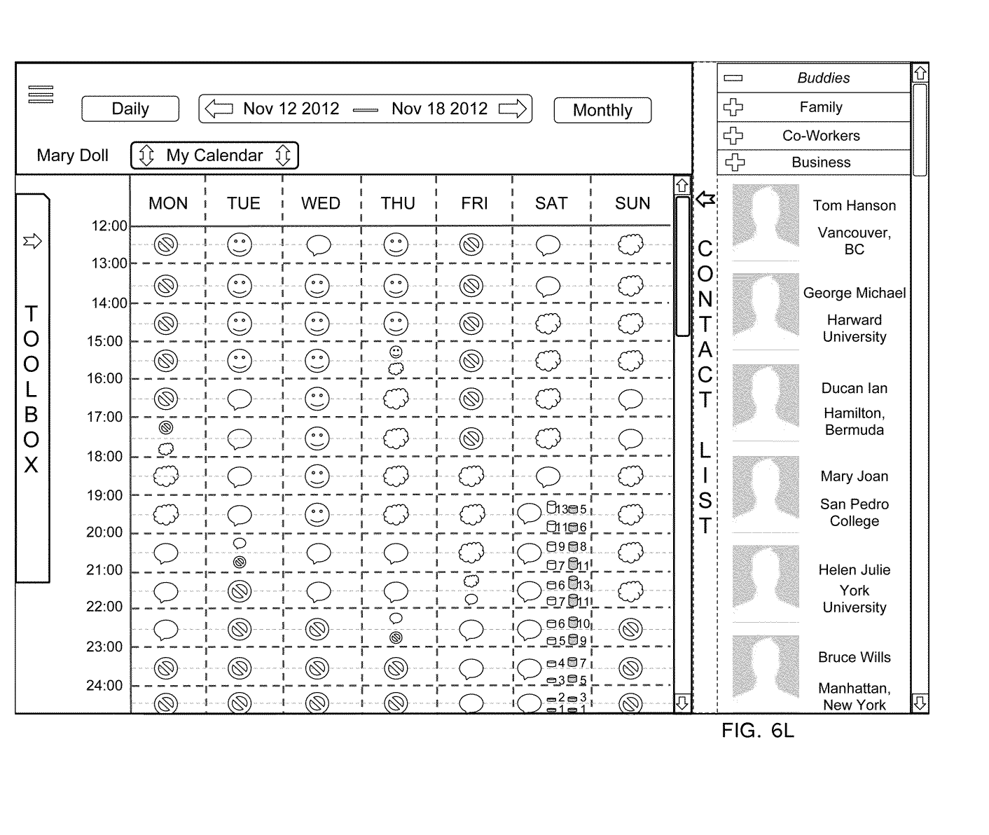

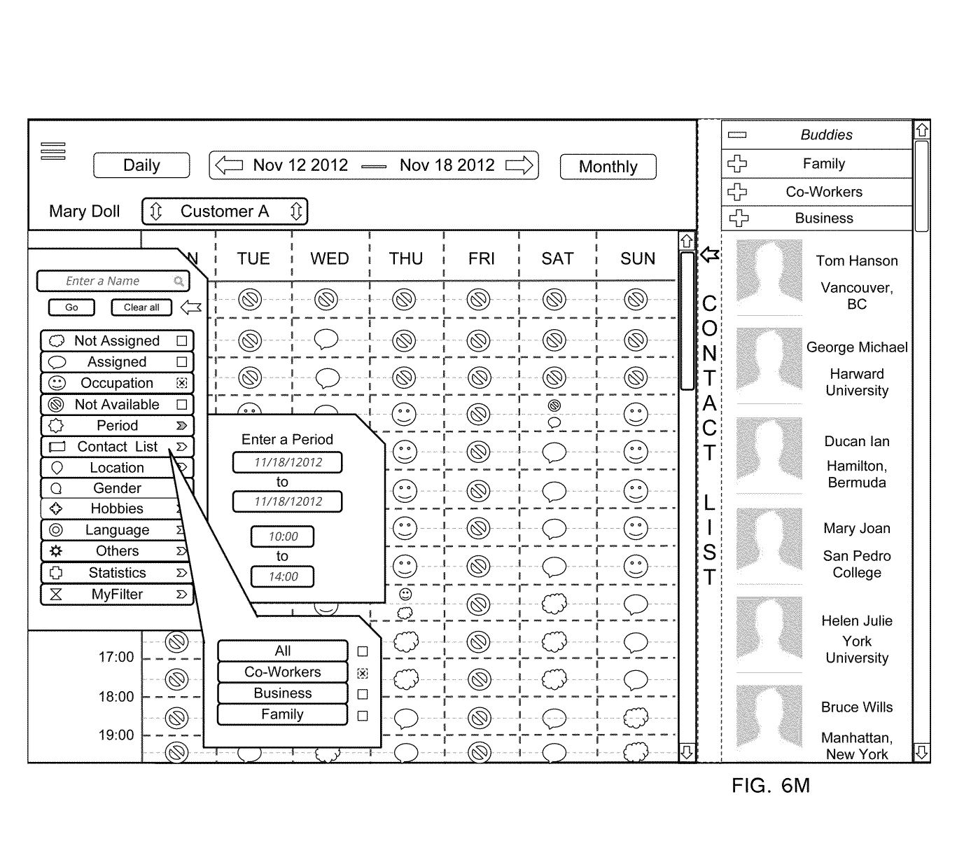

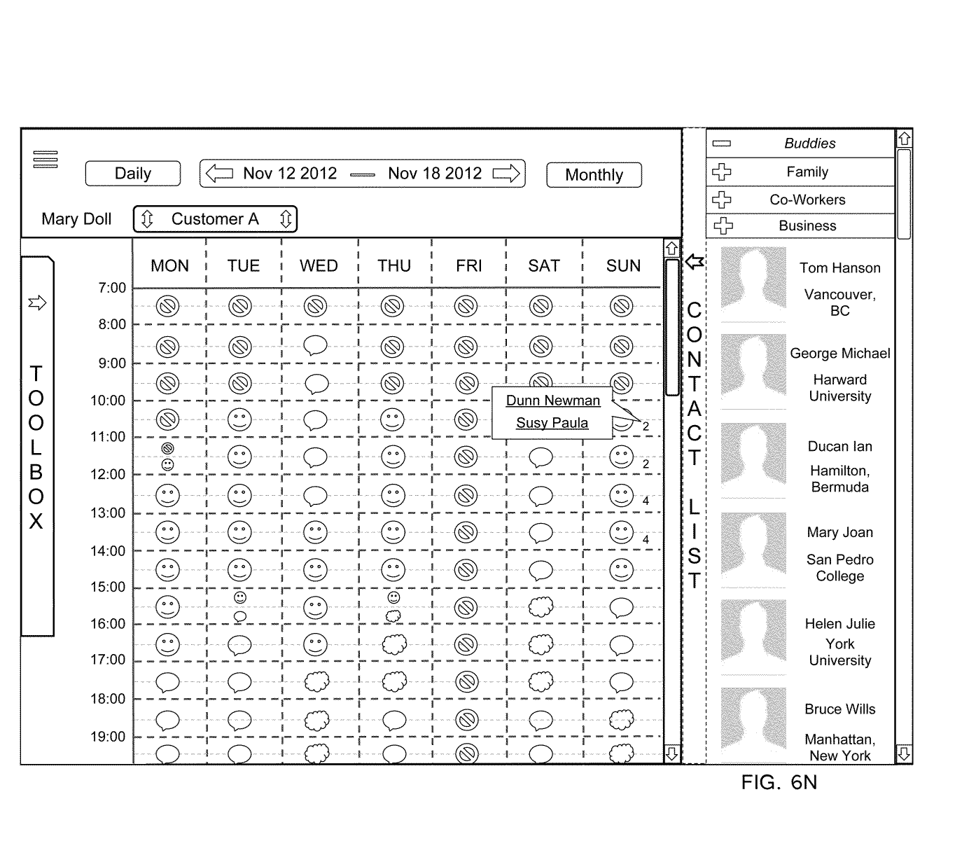

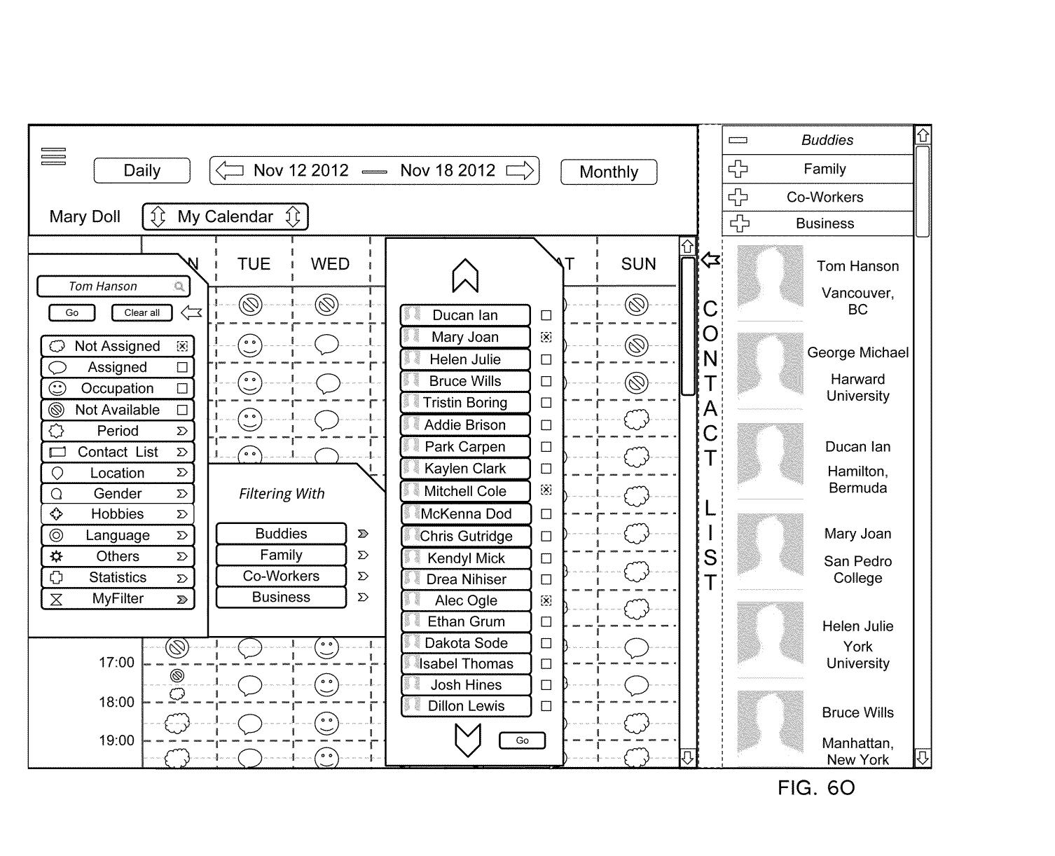

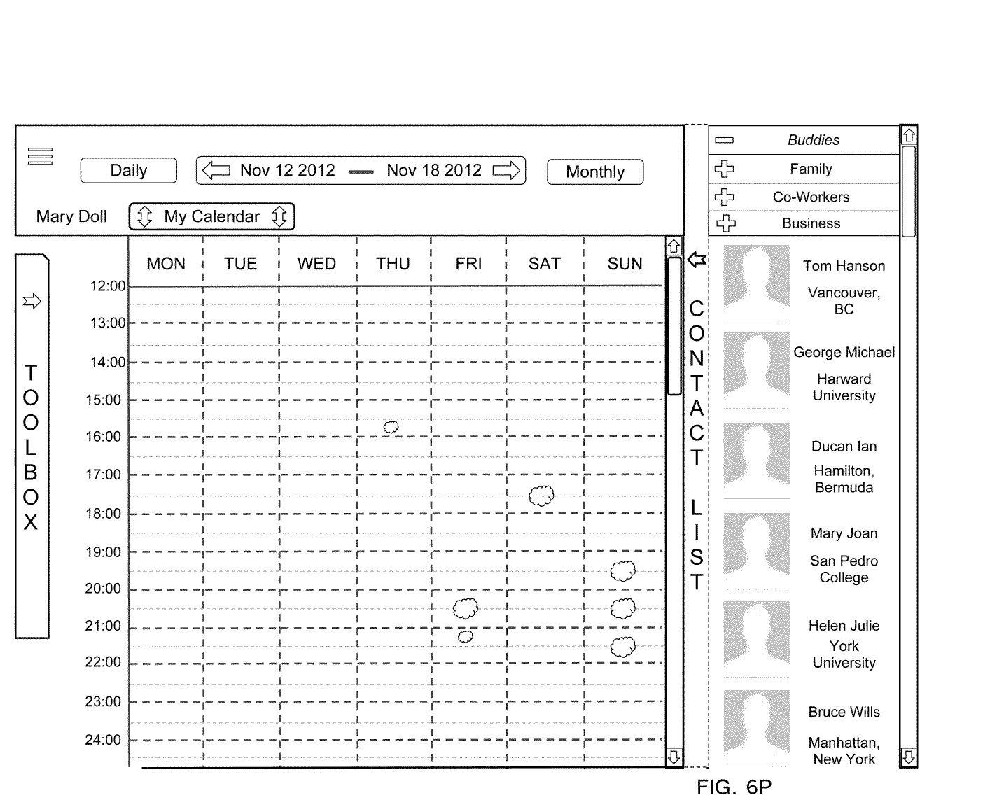

Turning now to FIGS. 6A-6P, exemplary embodiments of a user interface as provided by the system, are shown.

FIG. 6A shows a weekly calendar comprising mainly three parts: a calendar, a tool box and a contact list. Each period of time identified in the calendar element is marked by an icon denoting the type of activity provided for in that specific time period. An exemplary legend for these icons can be found in FIG. 6B.

FIG. 6B shows a legend for the various types of categories of calendar elements, in accordance with an embodiment of the present invention. While the legend of FIG. 6B identifies numerous icons denoting the various types of categories of calendar elements, one of ordinary skill in the art would appreciate that there are numerous types of icons and types of calendar elements that could be denoted by various other types of icons in accordance with an embodiment of the present invention, and embodiments of the present invention are contemplated for use with any type of icon and calendar element representation.

FIG. 6C shows an expanded weekly calendar, in accordance with an embodiment of the present invention. FIG. 6C further shows an expanded toolbox with various search elements and other interface elements available when the toolbox is in the expanded state.

FIG. 6D shows a daily calendar, in accordance with an embodiment of the present invention. FIG. 6D further shows how various states of calendar elements can be displayed by the system. For instance, the system can present both accepted and proposed calendar elements as well as notes and other comments (e.g., TO-DO) for consumption by the user.

FIG. 6E shows a monthly calendar, in accordance with an embodiment of the present invention.

FIG. 6F shows an expanded weekly calendar of a second user as viewed by a first user, where the second user is a member of a contact list of the first user, in accordance with an embodiment of the present invention. It is assumed in this display that the second user has given permissions to the first user to view the calendar or the calendar of the second user is publicly available.

FIG. 6G shows an expanded weekly calendar a first user (Mary Doll) conducting a search for the calendar of a second user (Tom Hanson). In certain embodiments, selecting a second user's name from the contact list can automatically populate a search item in the toolbox of the GUI.

FIG. 6H shows an statistics request GUI, in accordance with an embodiment of the present invention. Identified in FIG. 6H are some potential filters and search options utilizable by the system for generating appropriate statistical data (e.g., Period, Location, Type of Statistics).

FIG. 6I shows an expanded weekly calendar provided as a result of a search of multiple users calendars to find times that matches specific filters. For instance, the data in FIG. 6I is the results of a first user searching a plurality of users' calendars based on location information and availability information.

FIG. 6J-K shows an exemplary embodiment of a search for users based on (i) “not assigned time” and “assigned time”; (ii) from 19:00-24:00 on Nov. 17, 2012; (iii) female contacts only; and (iv) location is currently in Seattle, Wash. (note: location can be independent of the searching user's location). The time grid displayed in FIGS. 6J-K shows results for every half an hour with results being returned in both figure and graph format.

FIG. 6L shows an expanded weekly calendar of a second user as viewed by a first user, where the second user is a member of a contact list of the first user and the first user performed a search utilizing the second user's calendar as the root calendar (i.e., as if the calendar of the second user belonged to the first user).

FIG. 6M shows an exemplary embodiment of a search conducted by a first user (Mary Doll) whereby the first user utilizes the calendar of a second user (e.g., Customer A) to conduct the search. FIG. 6N shows the matching results of the search in FIG. 6M.

FIG. 6O shows an expanded weekly calendar of a user with an open toolbox and potential search criteria/filters to be applied. FIG. 6P shows an expanded weekly calendar of a plurality of users where a first user is searching numerous calendars to find specific event members or time classifications common among the calendars of each individual user of the plurality of users. Specifically, FIG. 6P is the result set of that filtering, showing matching times for those times where there are a match amongst the various users being filtered on.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A web-based system for providing advanced calendar synchronization and filtration, the system comprising:
a calendar system module comprising computer-executable code stored in non-volatile memory;
a search engine module comprising computer-executable code stored in non-volatile memory;
a processor; and
a communications means,
wherein said calendar system module, said search engine module, said processor, and said communications means are operably connected and are configured to:
receive a request from a first user regarding calendars of one or more users;
identify a purpose for said request, wherein said purpose is selected from the group comprising retrieval of calendar elements, retrieval of profile data, filtering of calendar data and filtering of profile data; and
process said request based on said purpose, wherein said processing includes one or more of retrieving one or more calendar elements from a data store, retrieving one or more profile elements from said data, filtering said one or more calendar elements based on data contained in said request, and filtering said one or more profile elements based on data contained in said request.

2. The system of claim 1, wherein said calendar system module, said search engine module, said processor, and said communications means are operably connected and are further configured to generate statistical information about one or more calendar elements associated with said one or more users.

3. The system of claim 2, wherein said calendar system module, said search engine module, said processor, and said communications means are operably connected and are further configured to provide said statistical information to said user.

4. The system of claim 2, wherein said calendar system module, said search engine module, said processor, and said communications means are operably connected and are further configured to predict future calendar elements based on said statistical information.

5. The system of claim 2, wherein said calendar system module, said search engine module, said processor, and said communications means are operably connected and are further configured to filter said statistical information based on said request.

6. The system of claim 4, wherein said calendar system module, said search engine module, said processor, and said communications means are operably connected and are further configured to associate one or more of said predicted future calendar elements with the calendar of said user.

7. The system of claim 6, wherein said calendar system module, said search engine module, said processor, and said communications means are operably connected and are further configured to store said one or more of said predicted future calendar elements.

8. The system of claim 1, further comprising a calendar interface element, wherein said calendar interface element is displayed on a computing device of said user and is communicatively connected to said communications means in a manner allowing said communications means to communicate data associated with one or more of the group comprising graphs and figures, whereby said calendar interface element displays one or more of the group comprising graphs and figures on said computing device.

9. A web-based method for providing advanced calendar synchronization and filtration, the method comprising the steps of:
receiving a request from a first user regarding calendars of one or more users;
identifying a purpose for said request, wherein said purpose is selected from the group comprising retrieval of calendar elements, retrieval of profile data, filtering of calendar data and filtering of profile data; and
processing said request based on said purpose, wherein said processing includes one or more of retrieving one or more calendar elements from a data store, retrieving one or more profile elements from said data, filtering said one or more calendar elements based on data contained in said request, and filtering said one or more profile elements based on data contained in said request.

10. The method of claim 9, further comprising the step of generating statistical information about one or more calendar elements associated with said one or more users.

11. The method of claim 10, further comprising the step of providing said statistical information to said user.

12. The method of claim 10, further comprising the step of predicting future calendar elements based on said statistical information.

13. The method of claim 10, further comprising the step of filter said statistical information based on said request.

14. The method of claim 12, further comprising the step of associating one or more of said predicted future calendar elements with the calendar of said user.

15. The method of claim 14, further comprising the step of storing said one or more of said predicted future calendar elements.

16. The method of claim 9, further comprising the step of displaying, on a calendar interface of a computing device of said first user, one or more elements from the group of elements comprising graphs and figures.
